(19) United States
(12) Patent Application Publication
(10) Pub. No.: US 2019/0004411 A1
(43) Pub. Date: Jan. 3, 2019

(54) VIRTUAL IMAGE DISPLAY DEVICE

(71) Applicant: JVC KENWOOD Corporation, Yokohama-shi (JP)

(72) Inventor: Shigeaki ITO, Yokohama-shi (JP)

(21) Appl. No.: 16/021,198

(22) Filed: Jun. 28, 2018

(30) Foreign Application Priority Data
Jun. 30, 2017 (JP) 2017-128731

(51) Int. Cl. G03B 21/28; G02B 27/01; G02B 27/09

(52) U.S. Cl. CPC G03B 21/28; G02B 27/0101; B60K 2350/2052; G02B 2027/014; G02B 27/0983

(57) ABSTRACT

A virtual image display device includes: a projection unit that projects an image display light; a concave mirror that reflects the image display light toward a virtual image presentation plane; and a driving mechanism that changes an orientation and position of the concave mirror. The driving mechanism rotates the concave mirror around a rotation axis perpendicular to both an incidence direction and an outgoing direction of a principal ray of the image display light on the concave mirror, and moves the concave mirror in a direction along the incidence direction of the principal ray of the image display light on the concave mirror in accordance with a change in an angle of the concave mirror around the rotation axis.

### CROSS REFERENCE TO RELATED APPLICATION

Priority is claimed to Japanese Patent Application No. 2017-128731, filed on Jun. 30, 2017, the entire content of which is incorporated herein by reference.

### BACKGROUND

### 1. Field of the Invention

The present invention relates to a virtual image display device.

### 2. Description of the Related Art

Recently, head-up displays are available for use as display devices for vehicles. A head-up display projects an image display light toward, for example, a windshield of a vehicle, superimposes a virtual image based on the image display light on the scenery outside the vehicle and displays the resultant image. A concave mirror for enlarging a real image based on the image display light and projecting the enlarged image may be used in head-up displays. For presentation of a virtual image at a position adapted to the height of the eyes of the user, the angle of the concave mirror, for example, is configured to be adjustable.

When the angle of the concave mirror projecting the image display light onto the windshield is changed, the position of incidence of the image display light on the windshield may be changed. Often, the curved shape of the windshield is not uniform so that if a change in the position of incidence of the image display light is accompanied by a change in the radius of curvature at the position of incidence, the virtual image presented may be distorted.

### SUMMARY

A virtual image display device according to an embodiment of the present invention comprises: a projection unit that projects an image display light; a concave mirror that reflects the image display light toward a virtual image presentation plane; and a driving mechanism that changes an orientation and position of the concave mirror. The driving mechanism rotates the concave mirror around a rotation axis perpendicular to both an incidence direction and an outgoing direction of a principal ray of the image display light on the concave mirror and moves the concave mirror in a direction along the incidence direction of the principal ray of the image display light on the concave mirror in accordance with a change in an angle of the concave mirror around the rotation axis.

Optional combinations of the aforementioned constituting elements, and implementations of the invention in the form of methods, apparatuses, and systems may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 schematically shows a configuration of a virtual image display device according to the embodiment;

FIG. 2 schematically shows a method of adjusting a virtual image presentation position in a virtual image display device according to a comparative example;

FIG. 3 schematically shows a method of adjusting a virtual image presentation position according to the embodiment;

FIG. 4 schematically shows a relationship between an amount of angular change and an amount of movement of the concave mirror; and

FIG. 5 schematically shows a configuration of the driving mechanism according to the embodiment.

### DETAILED DESCRIPTION

The invention will now be described by reference to the preferred embodiments. This does not intend to limit the scope of the present invention, but to exemplify the invention.

A description will be given of embodiments of the present invention with reference to the drawings. Specific numerical values are shown in the embodiments by way of example only to facilitate the understanding of the invention and should not be construed as limiting the scope of the invention unless specifically indicated as such. Those elements in the specification and drawings that have substantially identical functions and structures are represented by the same reference symbols so that the description is not duplicated. Elements not directly relevant to the invention directly are omitted from the illustration.

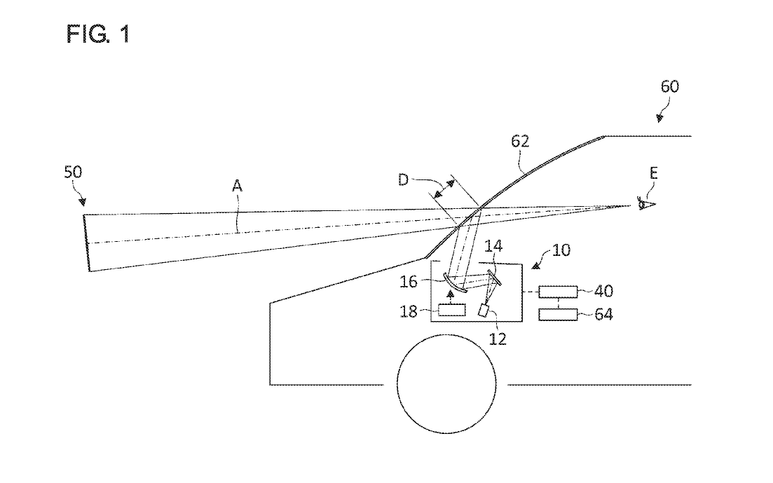

FIG. 1 schematically shows how a virtual image display device 10 according to the embodiment is installed. In this embodiment, a virtual image display device 10 is installed in a dashboard of a vehicle 60, which exemplifies a moving object. The virtual image display device 10 is a so-called head-up display device. The virtual image display device 10 presents a virtual image 50 in front of the vehicle 60 in the direction of travel (leftward direction in FIG. 1) by projecting an image display light toward a windshield 62, which represents a virtual image presentation plane. The user E (e.g., the driver) can see the virtual image 50 superimposed on the actual scenery via the windshield 62. Therefore, the driver E can access information shown in the virtual image 50 substantially without moving the line of sight while driving the vehicle.

The virtual image display device 10 includes a projection unit 12, a reflection mirror 14, a concave mirror 16, a driving mechanism 18, and a control unit 30. The projection unit 12 modulates an illumination light by using an image display device and generates the image display light corresponding to a display image of the image display device. The projection unit 12 includes a reflective display device such as a Liquid Crystal On Silicon (LCOS) device or a transmissive display device such as a Thin Film Transistor (TFT) liquid crystal display panel. The projection unit 12 may be configured to generate the image display light according to the raster scan system or may include a Micro Electro Mechanical Systems (MEMS) mirror for modulating and scanning a laser beam.

The reflection mirror 14 is a return mirror for returning the image display light from the projection unit 12 toward the concave mirror 16. The reflection mirror 14 may be configured to be flat or curved. The surface of the reflection mirror 14 may be shaped in a convex curve or a concave curve to correct the aberration of the optical system. The reflection mirror 14 may not be provided and the image display light from the projection unit 12 may be directly projected to the concave mirror 16. Alternatively, a plurality of reflection mirrors 14 may be provided and the light path from the projection unit 12 to the concave mirror 16 may be folded multiple times.

The concave mirror 16 is a projection mirror that reflects the image display light from the projection unit 12 toward the windshield 62, which represents a virtual image presentation plane. The concave mirror 16 enlarges an image based on the image display light and presents the enlarged image to the user E. The user E recognizes the image based on the image display light as the virtual image 50.

The beam of the image display light projected by the concave mirror 16 has a certain size and has a certain size (image size) on the windshield 62. The image size on the windshield 62 is defined as a size of an area on the surface of the windshield 62 where the beam of image display light is incident and reflected. The dimension indicated by a symbol D in FIG. 1 corresponds to the dimension in the vertical direction of the image visible as the virtual image 50.

The driving mechanism 18 changes the orientation and position of the concave mirror 16. The driving mechanism 18 changes the direction of the image display light directed from the windshield 62 toward the user E by changing the orientation of the concave mirror 6 to ensure that the image display light is projected in a proper direction adapted to the height of the eyes of the user E. The driving mechanism 18 changes the position of the concave mirror 16 along the direction of incidence of the principal ray of the image display light on the concave mirror 16. This ensures that the position of incidence and reflection of the image display light on the windshield 62 is fixed. The mechanism for fixing the position of the image display light will be discussed later.

The control unit 40 generates an image for display and operates the projection unit 12 and the driving mechanism 18 to present the virtual image 50 corresponding to the image for display. The control unit 40 is connected to an external device 64 and generates the image for display based on the information from the external device 64.

The external device 64 is a device for generating original data for an image displayed as the virtual image 50. For example, the external device 64 may be an Electronic Control Unit (ECU) for the vehicle 60, a navigation device, or a mobile device such as a cell phone, smartphone, tablet, etc. The external device 64 transmits, to the control unit 40, image data necessary to display the virtual image 50, information indicating the content and type of the image data, and information related to the vehicle 60 such as the speed and current position of the vehicle 60.

The embodiment is characterized in that both the orientation and position of the concave mirror 16 can be adjusted by the driving mechanism 18. By changing the orientation and position of the concave mirror 16 at the same time, the orientation of the image display light traveling toward the user E can be changed, while maintaining the position of incidence and reflection of the image display light on the windshield 62 fixed. Before describing the embodiment that realizes the fixed position of the image display light on the windshield 62, a description will be given of the change in the position of incidence and reflection of the image display light on the windshield 62 with reference to a comparative example.

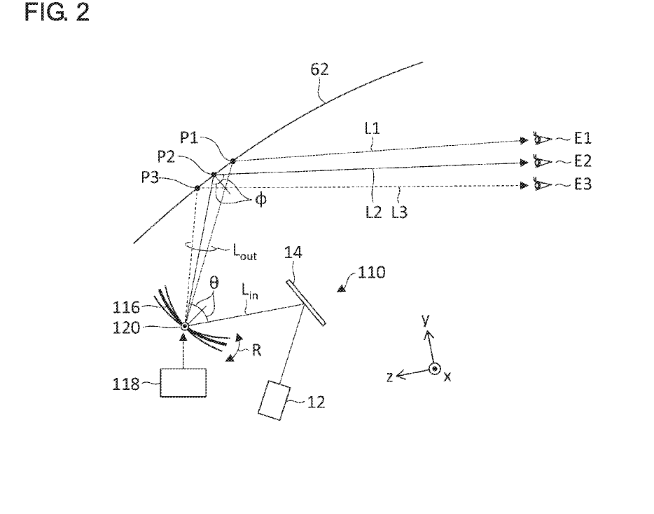

FIG. 2 schematically shows a method of adjusting a virtual image presentation position in a virtual image display device 110 according to a comparative example. FIG. 2 shows light paths L1, L2, and L3 of the principal ray of the image display light occurring when the image display light oriented properly is provided for users E1, E2, and E3 that differ in the height of the eyes. Referring to FIG. 2, the incidence direction of the principal ray Lin of the image display light traveling toward a concave mirror 116 is defined as the z direction, the direction perpendicular to both the incident principal ray Lin and an outgoing principal ray Lout is defined as the x direction, and the direction perpendicular to the z direction and the x direction is defined as the y direction. The rotation axis 120 of the concave mirror 116 is aligned with the x direction.

Unlike the case of the embodiment described above, the light paths L1˜L3 of the image display light are adjusted by changing only the orientation of the concave mirror 116. The driving mechanism 118 adjusts the the orientation of the concave mirror 116 by rotating the concave mirror 116 as indicated by arrow R. By rotating the concave mirror 116 to increase the angle θ of incidence and reflection of the principal ray on the concave mirror 116, the angle φ of incidence and reflection of the principal ray on the windshield 62 is reduced. Conversely, by decreasing the angle θ of incidence and reflection of the principal ray on the concave mirror 116, the angle φ of incidence and reflection on the windshield 62 is increased. This ensures that the image display light is projected in directions suitable for the users E1˜E3 that differ in the height of the eyes.

In this comparative example, the point of incidence of the incident principal ray Lin and the point of exit of the outgoing principal ray Lout on the concave mirror 116 are fixed so that the positions P1, P2, and P3 of the principal ray of the image display light on the windshield 62 changes as the outgoing direction of the outgoing principal ray Lout changes. Generally, the curved surface shape of the windshield 62 is not uniform. The gradient or radius of curvature may change depending on the location so that the optical property relative to the image display light may change depending on the position on the windshield 62. For example, if the radius of curvature differs between the positions P1˜P3 of incidence and reflection of the principal ray of the image display light shown in FIG. 2, the magnification factors of the virtual image 50 presented via the respective positions P1˜P3 will differ. Further, the beam of the image display light has a certain size so that the area (also referred to as display area) of incidence and reflection of the beam of the image display light as a whole on the windshield 62 changes as the position of the principal ray change between P1˜P3. If the curved surface shape of the display area changes due to the change in the position of the display area on the windshield 62, the imaging property of the image display light changes, creating a distortion in the virtual image 50 presented. For example, in the case where the control unit 40 generates, based on the information acquired from the external device 64, a display image for which the distortion is corrected such that the image is optimized when the position of the principal ray is P2, and the position of the principal ray is changed to P1 or P3, the virtual image 50 is distorted because of the different gradient or radius of curvature on the windshield 62 at the position P1 or P3.

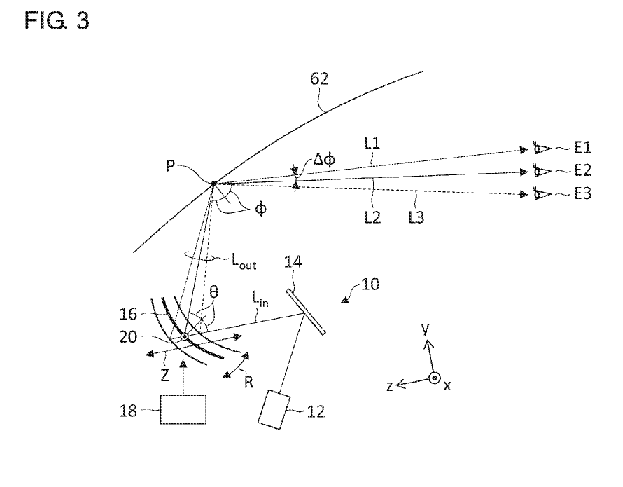

FIG. 3 schematically shows a method of adjusting a virtual image presentation position in the virtual image display device 110 according to the embodiment. In this embodiment, the orientation of the concave mirror 16 indicated by the arrow R and the position of the concave mirror 16 indicated by the arrow Z are configured to be variable. In this embodiment, as in the comparative example, the angle φ of incidence and reflection of the principal ray on the windshield 62 is adjusted by rotating the concave mirror 16 around the rotation axis 20 to change its orientation. In this embodiment, the position of the concave mirror 16 in the z direction is further adjusted so as not to change the position P of the principal ray on the windshield 62.

Referring to FIG. 3, to change from the second light path L2 leading to the second user E2 of the intermediate height to the first light path L1 leading to the first user E1 at a relatively high position by enlarging the angle φ of incidence and reflection of the principal ray on the windshield 62, the position of the concave mirror 16 is changed so as to be distanced from the reflection mirror 14. In other words, the concave mirror 16 is moved in the same direction (positive direction) as the direction of incidence (z direction) of the incident principal ray Lin on the concave mirror 16. Meanwhile, to change to the third light path P3 leading to the third user E3 at a relatively low position by reducing the angle φ of incidence and reflection of the principal ray on the windshield 62, the position of the concave mirror 16 is changed so as to be closer to the reflection mirror 14. In other words, the concave mirror 16 is moved in a direction opposite (negative direction) to the direction of incidence (z direction) of the incident principal ray Lin on the concave mirror 16.

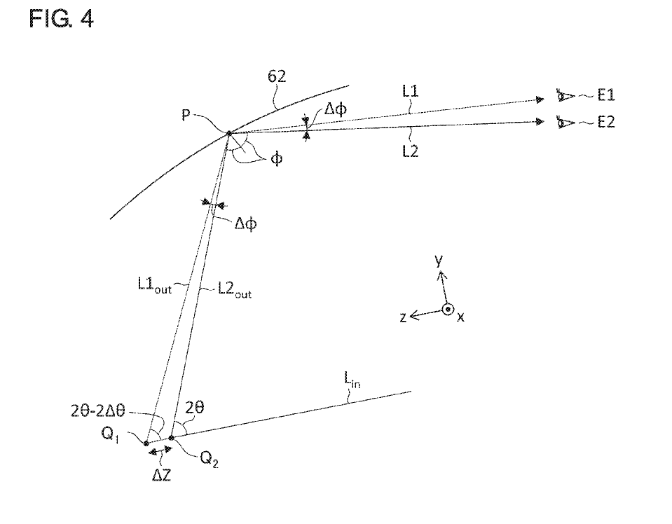

FIG. 4 schematically shows a relationship between an amount Δθ of angular change and an amount Δz of movement of the concave mirror 16. FIG. 4 shows an optical arrangement that results when the the second light path leading to the second user E2 is changed to the first light path L1 leading to the first user E1. The amount of change of the angle φ of incidence and reflection of the principal ray on the windshield 62 is denoted by Δφ, and the amount of angular change of the concave mirror 16 is denoted by A. The position of incidence and reflection of the principal ray on the concave mirror 16 in the first light path L1 is denoted by Q1, and the position of incidence and reflection of the principal ray on the concave mirror 16 in the second light path L2 is denoted by Q2. Further, the principal ray exiting the concave mirror 16 along the first light path L1 is denoted by a first outgoing principal ray L1out, and the principal ray exiting the concave mirror 16 along the second light path L2 is denoted by a second outgoing principal ray L2out.

In the light path arrangement of FIG. 4, the relationship between the position P of the principal ray on the windshield 62 and the incident principal ray Lin on the concave mirror 16 remains unchanged. For this reason, the sum (φ+2θ) of the angle φ of incidence of the principal ray on the windshield 62 and the angle θ of incidence plus the angle θ of reflection of the principal ray on the concave mirror 16 is constant. Therefore, the sum of angles {(φ+Δφ)+2(θ−Δθ)} in the first light path L1 is equal to the sum of angles (φ+2θ) in the second light path L2, and the amount of angular change of the concave mirror 16 is such that Δθ=Δφ/2.

Further, the amount Δz of movement of the concave mirror 16 in the z direction can be found by focusing on the triangle ΔPQ1Q2 formed by the position P of the principal ray on the windshield 62 and the positions Q1, Q2 of incidence and reflection on the concave mirror 16 in the first and second light paths L1, L2. Denoting the distance of the line segment PQ2 (i.e., the second outgoing principal ray L2out) by k, the sine theorem shows that k/sin(2θ−2Δθ)=Δz/sin(Δφ) so that it is given that Δz=k*sin(Δφ)/sin(2θ−2Δθ). Therefore, the amount Δθ of angular change and the amount Δz of movement of the concave mirror 16 are related such that Δz=k*sin(2Δθ)/sin(2θ−2Δθ). Thus, the amount Δz of movement of the concave mirror 16 is determined as a function of the amount Δθ of angular change of the concave mirror 16. Once the amount Δθ of angular change of the concave mirror 16 is determined, a proper amount Δz of movement is uniquely determined. The driving mechanism 18 adjusts the orientation and position of the concave mirror 16 so that the amount Δθ of angular change and the amount Δz of movement of the concave mirror 16 meet the above expression.

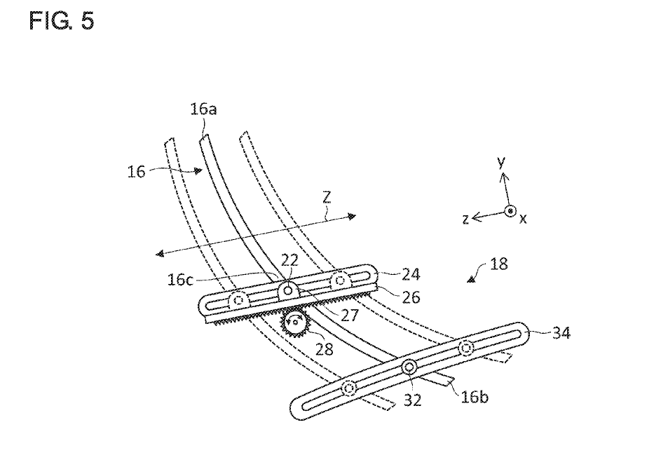

FIG. 5 schematically shows a configuration of the driving mechanism 18 according to the embodiment. The driving mechanism 18 is provided with a first support pin 22, a first guide rail 24, a rack gear 26, a drive gear 28, a second support pin 32, and a second guide rail 34. The driving mechanism 18 enables the concave mirror 16 to move in the z direction, while restricting the positions of the central part 16c and the lower end part 16b of the concave mirror 16 to orient the concave mirror 16 at a proper angle.

Referring to FIG. 5, the upper end part 16a, the lower end part 16b, and the central part 16c of the concave mirror 16 are used to identify the position of the concave mirror 16 in the y direction. The upper end part 16a refers to an end relatively close to the windshield 62, and the lower end part 16b refers to an end relatively remote from the windshield 62. The central part 16c is in the middle of the upper end part 16a and the lower end part 16b and is a part where the principal ray of the image display light is incident and reflected.

The first support pin 22 is provided in the central part 16c of the concave mirror 16 and is mounted to project from the side of the concave mirror 16 in the x direction. The first guide rail 24 extends linearly in the z direction and rotatably supports the first support pin 22. The first guide rail 24 is provided such that its position in the y direction coincides with the incident principal ray Lin on the concave mirror 16. The first guide rail 24 restricts the position of the concave mirror 16 in the y direction such that the incident principal ray Lin is incident on the central part 16c of the concave mirror 16. The rack gear 26 extends in the z direction along the first guide rail 24 and is configured to be movable in the z direction along the first guide rail 24. The rack gear 26 is fixed to the first support pin 22 via a bearing 27 of the first support pin 22. The drive gear 28 is configured to be driven by a drive source such as a motor (not shown) into rotation. As the drive gear 28 is rotated, the rack gear 26 moves in the z direction so that the concave mirror 16 is moved in the z direction along the first guide rail 24.

The second support pin 32 is provided at a position distanced from the central part 16c of the concave mirror 16 in the y direction. For example, the second support pin 32 is provided at the lower end part 16b or near the lower end part 16b of the concave mirror 16. The second guide rail 34 extends in a shape of an upwardly convex arc and rotatably supports the second support pin 32. The second guide rail 34 extends substantially in the z direction but is angled in the y direction. Therefore, the second guide rail 34 is configured such that at least one of the shape and orientation thereof is different from that of the first guide rail 24. By restricting the position of the lower end part 16b or the neighborhood of the lower end part 16b of the concave mirror 16 by using the second guide rail 34 as described above, the position and orientation of the concave mirror 16 are changed in coordination to maintain the position P of the principal ray on the windshield 62 fixed.

According to the configuration described above, by changing the position of the concave mirror 16 in the z direction properly in accordance with the orientation of the concave mirror 16, the virtual image presentation position can be adjusted such that the position P of the principal ray on the windshield 62, which represents a virtual image presentation plane, is fixed. This inhibits the optical property from being changed due to the change in the position of the principal ray on the windshield 62 and maintains the performance for imaging the image display light at a constant level or higher. Accordingly, the embodiment reduces the distortion of the virtual image 50 associated with the adjustment of the virtual image presentation position and allows presentation of a highly visible virtual image 50, while also providing the capability for variable virtual image presentation positions.

It should be noted that the configuration of the driving mechanism 18 is not limited to that of FIG. 5 and other configurations may be used. In the case of controlling the position and orientation of the concave mirror 16 by using two guide rails provided at different positions in the y direction, the first guide rail provided in the central part 16c of the concave mirror 16 and the second guide rail provided in the upper end part 16a or near the upper end part 16a of the concave mirror 16 may be used. Alternatively, the guide rail may be provided in each of the upper end part 16a and the lower end part 16b, and the guide rail may not be provided in the central part 16c. In any case, the orientation and position of the concave mirror 16 can be suitably adjusted by ensuring that the two guide rails differ in at least one of the shape and orientation.

The present invention has been described above with reference to the embodiment but is not limited to the embodiment. Appropriate combinations or replacements of the features of the illustrated examples are also encompassed by the present invention.

In the embodiment described above, the method of adjusting the angle φ of incidence and reflection of the principal ray on the virtual image presentation plane while maintaining the position P of the principal ray on the virtual image presentation plane fixed has been described. In one variation, the position of the principal ray on the virtual image presentation plane may not be strictly fixed and may be confined to a certain range. For example, the position of the image display light on the virtual image presentation plane may change slightly within a limited range of display area on the virtual image presentation plane in accordance with the change in the orientation and position of the concave mirror. For example, the position of the image display light on the virtual image presentation plane may change if the change is within a range where the curved shape of the virtual image presentation plane is substantially uniform. While it is not easy to identify the size of such a range of display area, the range may be defined to be 1.2 times the dimension D of the image size on the virtual image presentation plane as shown in FIG. 1 or less, by way of example. The closer the ratio to 1.0 times, the better (e.g., 1.1 times or less). In the comparative example of FIG. 2, the position of the image display light can move over a range of about 1.2 times˜1.5 times the dimension D of the image size at a maximum as a result of the adjustment of the virtual image presentation position. Therefore, the distortion of the image associated with the change in the position may be noticeable. Meanwhile, the distortion of the image is suitably reduced according to the variation by approximating the range of movement of the position of the image display light on the virtual image presentation plane to 1.2 times the dimension D of the image size or less or, preferably, by approximating the ratio to 1.0 times.

In the embodiment described above, the case of positioning the concave mirror 16 such that the incident principal ray Lin incident on the concave mirror 16 coincides with the central part 16c of the concave mirror 16 is illustrated. In one variation, the concave mirror 16 may be positioned such that the central part 16c of the concave mirror 16 is displaced from the incident principal ray Lin so long as the displacement is within a certain range. More specifically, a positional displacement may be created between the concave mirror 16 and the incident principal ray Lin within a range where the radius of curvature of the concave mirror 16 is considered to be uniform. For example, a displacement in a range of about 1%˜5% of the focal distance of the concave mirror 16 may be created. Even in a case like this, the distortion of the image associated with the adjustment of the virtual image presentation position can be suitably reduced.

In the embodiment described above, the position and orientation of the concave mirror 16 are assumed to be controlled by means of a single drive source by using two guide rails. In one variation, a further drive source for rotating the concave mirror 16 may be used in combination in addition to the drive source for moving the concave mirror 16 in the z direction.

In the embodiment described above, the movement of the concave mirror 16 in the z direction is assumed to be the same direction as that of the incident principal ray Lin. Alternatively, the movement may not be strictly in the same direction so long as the position P of the principal ray on the windshield 62 remains unchanged or the change thereof is considered to be sufficiently small.

It should be understood that the invention is not limited to the above-described embodiment but may be modified into various forms on the basis of the spirit of the invention. Additionally, the modifications are included in the scope of the invention.

What is claimed is:

1. A virtual image display device comprising:
a projection unit that projects an image display light;
a concave mirror that reflects the image display light toward a virtual image presentation plane; and
a driving mechanism that changes an orientation and position of the concave mirror, wherein
the driving mechanism rotates the concave mirror around a rotation axis perpendicular to both an incidence direction and an outgoing direction of a principal ray of the image display light on the concave mirror and moves the concave mirror in a direction along the incidence direction of the principal ray of the image display light on the concave mirror in accordance with a change in an angle of the concave mirror around the rotation axis.

2. The virtual image display device according to claim 1, wherein
the driving mechanism:
a) moves the concave mirror in the incidence direction of the principal ray of the image display light on the concave mirror when the angle of the concave mirror is changed to reduce an incidence angle of the image display light on the concave mirror, and
b) moves the concave mirror in a direction opposite to the incidence direction of the principal ray of the image display light on the concave mirror when the angle of the concave mirror is changed to enlarge an incidence angle of the image display light on the concave mirror.

3. The virtual image display device according to claim 1, wherein
the driving mechanism changes the orientation and position of the concave mirror such that the image display light is incident in a limited display area on the virtual image presentation plane before and after a change in the orientation and position of the concave mirror.

4. The virtual image display device according to claim 3, wherein
a size of the display area is a range in which a curved surface shape of the virtual image presentation plane is substantially uniform.

5. The virtual image display device according to claim 3, wherein
a size of the display area is three times an image size the image display light on the virtual image presentation plane.

6. The virtual image display device according to claim 1, wherein
the driving mechanism changes the orientation and position of the concave mirror such that the principal ray of the image display light is incident on an identical point on the virtual image presentation plane before and after a change in the orientation and position of the concave mirror.

7. The virtual image display device according to claim 1, wherein
defining a direction of the rotational axis of the concave mirror as x direction, defining the incidence direction of the image display light on the concave mirror as z direction, and defining a direction perpendicular to both the x direction and the z direction as y direction,
the driving mechanism includes a first guide rail and a second guide rail configured to support the concave mirror and to enable the concave mirror to move in the z direction,
the first guide rail is configured to extend linearly or in an arc, and
the second guide rail is provided at a distance from the first guide rail in the y direction and is configured to extend linearly or in an arc such that at least one of the shape and orientation of the second guide rail is different from that of the first guide rail.

8. The virtual image display device according to claim 7, wherein
the first guide rail is configured to extend linearly in the z direction and support a neighborhood of a center of the concave mirror in the y direction, and
the second guide rail is configured to extend in an arc and support a position of the concave mirror at a distance in the y direction from the neighborhood of the center.
